(19) United States
(12) Patent Application Publication
(10) Pub. No.: US 2024/0156077 A1
(43) Pub. Date: May 16, 2024

(54) Multi-Rotational Pull Lever Fishing Reel

(71) Applicant: Michael Sherman, Los Angeles, CA (US)

(72) Inventor: Michael Sherman, Los Angeles, CA (US)

(21) Appl. No.: 17/988,670

(22) Filed: Nov. 16, 2022

(51) Int. Cl. A01K 89/00; A01K 89/015

(52) U.S. Cl. CPC A01K 89/009; A01K 89/004; A01K 89/0185

(57) ABSTRACT

The present invention concerns generally with a device for reeling in fishing tackle in a more efficient and convenient way by increasing the rotational speed of reeling in via the proposed pull lever mechanism.

### FIELD OF THE INVENTION

The present invention is in the technical field of fishing reels and fishing equipment. Specifically, the present invention describes a device for reeling in fishing tackle by using fewer motions comparing to existing fishing tackle reeling devices and reducing the amount of physical effort during the process of reeling in fishing tackle.

### BACKGROUND OF THE INVENTION

Utilizing a typical bait casting reel, the angler releases the fishing line by toggling a release switch thus allowing the spool to rotate freely and release the line as necessary. When a sufficient amount of the line is released, the angler toggles the release switch back; thus, stopping the free rotation of the spool. When a fish is hooked, the angler grips the crank handle and rotates it as necessary to reel in the line.

This traditional method of reeling in fishing tackle by constantly turning the crank handle places strain on the angler's fingers, hand, and wrist. The traditional means of reeling in involves “fighting” the fish by alternating between turning the crank handle to reel the line in and also giving the line a slack and allowing the fish to “run”. This action is intended to exhaust the fish and make it easier for the angler to reel it in. However, the unintended consequence is that the angler gets exhausted as well, having spent a considerable amount of time and physical energy to take the fish out of the water.

Typically, after just a few minutes of continually turning the crank handle and reeling in the fish, the angler is fatigued and sore while the fish is still in the water. Depending on the size and strength of the fish, reeling in can take a long time, and each subsequent crank handle rotation becomes more and more difficult for the angler.

Therefore, there is a need for a simple and reliable device that would make it easier to reel in fishing tackle. The proposed innovative solution described herein allows the angler to reel in fishing tackle by utilizing a completely different motion, one that causes less wear and tear on the body, as well as reeling in faster than the traditional method allows.

Instead of using a rotating wrist motion, the angler grips a lever arm handle and alternates between pulling and pushing the lever arm, mimicking natural bicep curl and arm/elbow hinge motions.

This allows the angler to utilize a completely different set of muscles, get more force behind each pull action and effectively rest as the lever arm returns back to its non-working state when released.

### SUMMARY OF THE INVENTION

The present invention describes a lever-based device for reeling in fishing tackle by using fewer motions comparing to the existing crank-based reeling devices.

It is principled on increasing the rotational speed when reeling in via a pull lever mechanism, which, in turn, reduces the amount of physical labor associated with reeling in.

By adding on a simple ratchet gear-based pull lever mechanism, the lever functions more naturally to a user's arm/elbow hinge motion, providing for more effective reeling and allowing conservation of energy for harder and longer catches.

After installing the proposed device onto an existing fishing reel, the user has a choice of either utilizing the proposed lever mechanism or the existing crank handle that comes standard on all fishing reels; the user can switch freely between the two.

A small extension within the device stops the lever at its resting position and disengages it from the ratchet mechanism. This was designed for the lever not to conflict with the conventional crank handle, especially upon the initial throw of fishing tackle.

In addition, this invention can be used by both right- and left-handed individuals.

### BRIEF DESCRIPTION OF THE DRAWINGS

These and other features of this invention will be more readily understood from the following detailed description of the various aspects of the invention taken in conjunction with the accompanying drawings.

FIG. 1 is the back-side interior view of the proposed device.

FIG. 2 is the handle-side cover exterior view of the proposed device.

FIG. 3 is the handle-side mounting plate interior view of the proposed device.

FIG. 4 depicts the internal components of the slip clutch assembly located next to the star drag and mounted on the drive shaft.

FIG. 5 is the individual component view of the lever arm assembly.

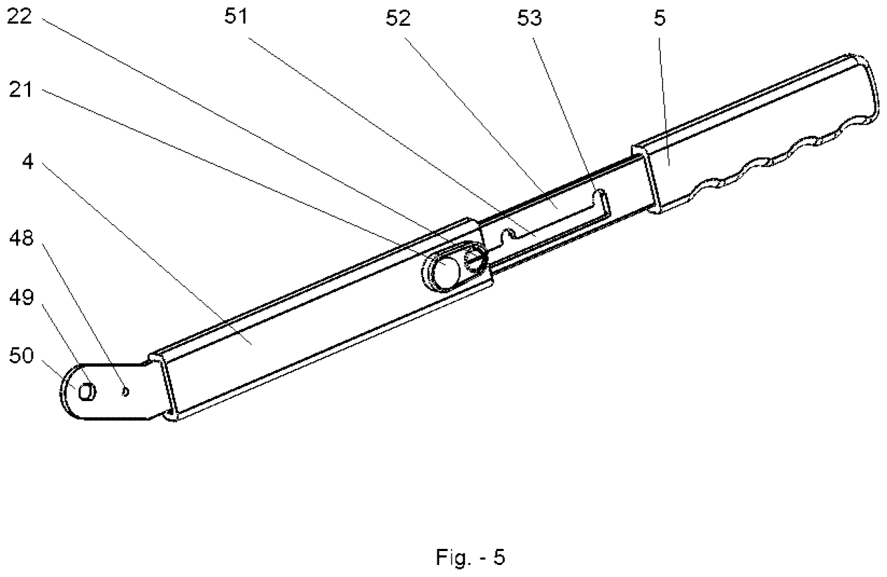

FIG. 6 is the full external component view with a cross-sectional external and internal component views, respectively.

### NUMBERING OF ELEMENTS

1. Handle side cover.
2. Crank.
3. Crank handle.
4. Pull lever arm.
5. Pull lever arm extendable handle.
6. Pull lever main gear.
7. Pull lever ratchet gear.
8. Pull lever driven gear.
9. Pinion gear.
10. Pull lever ratchet arm pawl.
11. Pull lever ratchet pawl stopper/limiter.
12. Pull lever ratchet pawl torsion spring.
13. Pull lever ratchet pawl pin.
14. Mounting plate.
15. Reel tension nut.
16. Star drag.
17. Crank cover.
18. Clutch system assembly.
19. Pull lever arm bolt cover.
20. Pull lever arm cover screw.
21. Pull lever arm extender lock.
22. Lever extender locks screw.
23. Handle side cover screw.
24. Release switch.
25. Release cam.
26. Release cam spring.
27. Clutch fork.
28. Clutch plate.
29. Main ratchet spring.
30. Main ratchet spring shoulder.
31. Drive gear.
32. Drive gear shaft bushing.
33. Drive shaft.
34. Pull lever arm return wheel.
35. Pull lever arm return wheel spacer.
36. Pull lever arms return wheel spring.
37. Pull lever arms return wheel shoulder.
38. Main antis reverse gear.
39. Tension clutch plate.
40. Tension clutch plate washer.
41. Drive shaft treaded mount.
42. Drive gear shaft bushing.
43. Clutch assembly “E” clip.
44. Crank mount and clutch “A”
45. Slip clutch “B”
46. Slip clutch spring.
47. Star drag treads.
48. Pull lever arm cover treaded screw mount.
49. Pull lever arm mount hole.
50. Pull lever arm mount plate.
51. Pull lever arm extension chandelled notch.
52. Pull lever arm extension slide surface.
53. Pull lever arm extension position notch.
54. Pull lever arm drive shaft.
55. Pull lever ratchet arm.
56. Pull lever bushing.
57. Pull lever shaft arm bolt.
58. Pull lever shaft end screw.
59. Spool shaft “C”.

### DETAILED DESCRIPTION OF THE INVENTION

The following is a detailed description of the invention provided to aid those skilled in the art in practicing in the field of the present invention. Those of ordinary skill in the art may make modifications and variations in the embodiments described herein without departing from the spirit or scope of the present invention. Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. All publications, patent applications, patents, figures, and other references mentioned herein are expressly incorporated by reference in their entirety.

The present invention is directed at a gear-based pull lever mechanism for reeling in fishing tackle. The mechanism described herein allows to reel in fish by using fewer motions comparing to the existing crank-based reeling devices. It is principled on increasing the rotational speed when reeling in via a pull lever mechanism, which, in turn, reduces the amount of physical labor associated with reeling in fishing tackle.

By adding on a simple ratchet gear-based pull lever mechanism, the lever functions more naturally to a user's arm/elbow hinge motions; thus, providing for more effective reeling and allowing conservation of energy for harder and longer catches.

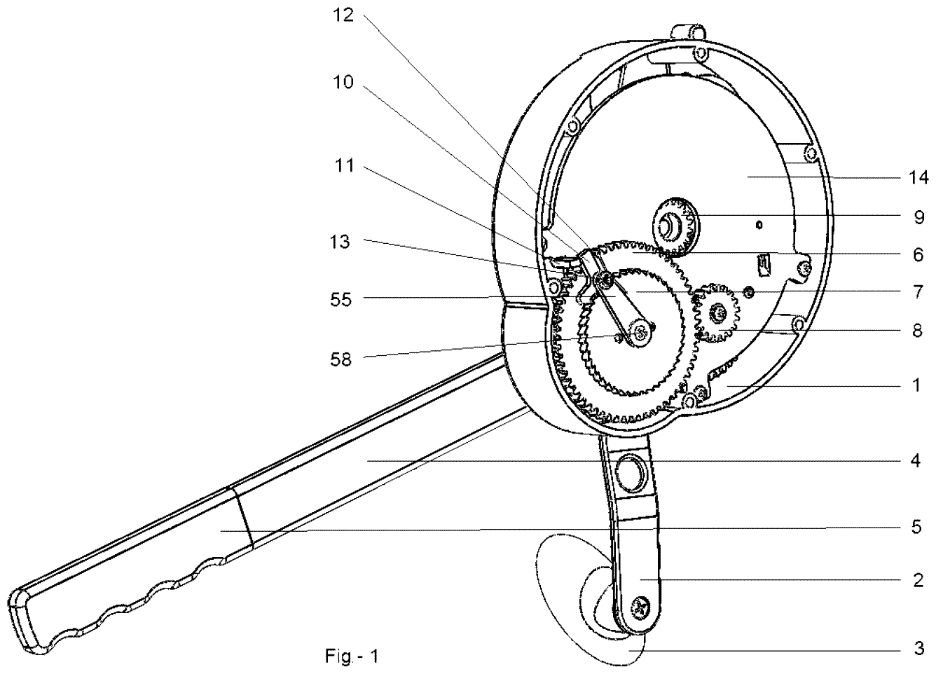

Referring to FIG. 1, the lever arm (4) is shown in a non-working state with the lever arm extendable handle (5) in its most retracted position. The lever main gear (6), the attached to it lever ratchet gear (7) and the lever ratchet arm (55) are positioned on the lever arm shaft (54) and secured by the lever end shaft screw (58). The lever main gear (6) is mechanically engaged with the lever drive gear (8) having a plurality of cogs and located on a parallel shaft. In one exemplary embodiment shown in FIG. 1, the lever drive gear (8) has 18 cogs. The lever drive gear (8) is mechanically attached to the drive shaft (33).

The lever ratchet arm pawl (10) is connected to the lever ratchet arm (55) by a lever ratchet pawl pin (13) and is tensioned by a lever ratchet pawl torsion spring (12). When the lever arm is disengaged and is not in use, the lever ratchet arm pawl (10) is disengaged from the lever ratchet gear (7).

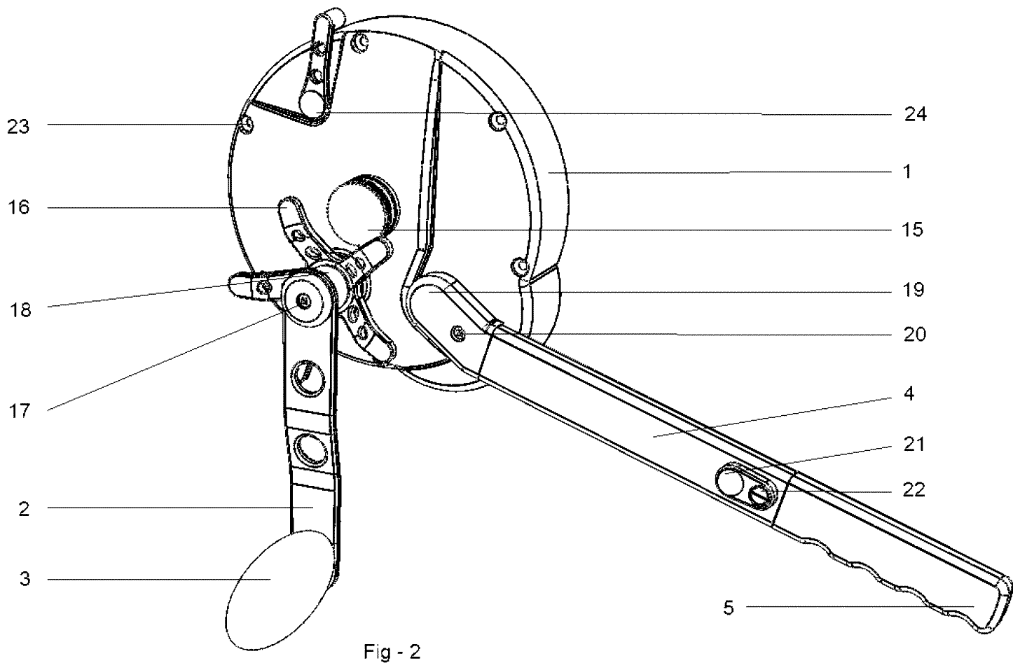

FIG. 2 shows the lever arm (4) in the non-working state and the lever arm extendable handle (5) is in its most retracted position. The lever arm extender lock (21) is held in place on the lever arm (4) by the lever arm extender screw (22). The lever cover (19) is attached to the arm by a lever cover screw (20). The lever arm (4) is placed in such a way that that there is a sufficient room between the lever arm (4) and the crank (2) and crank handle (3), which are not part of the present invention.

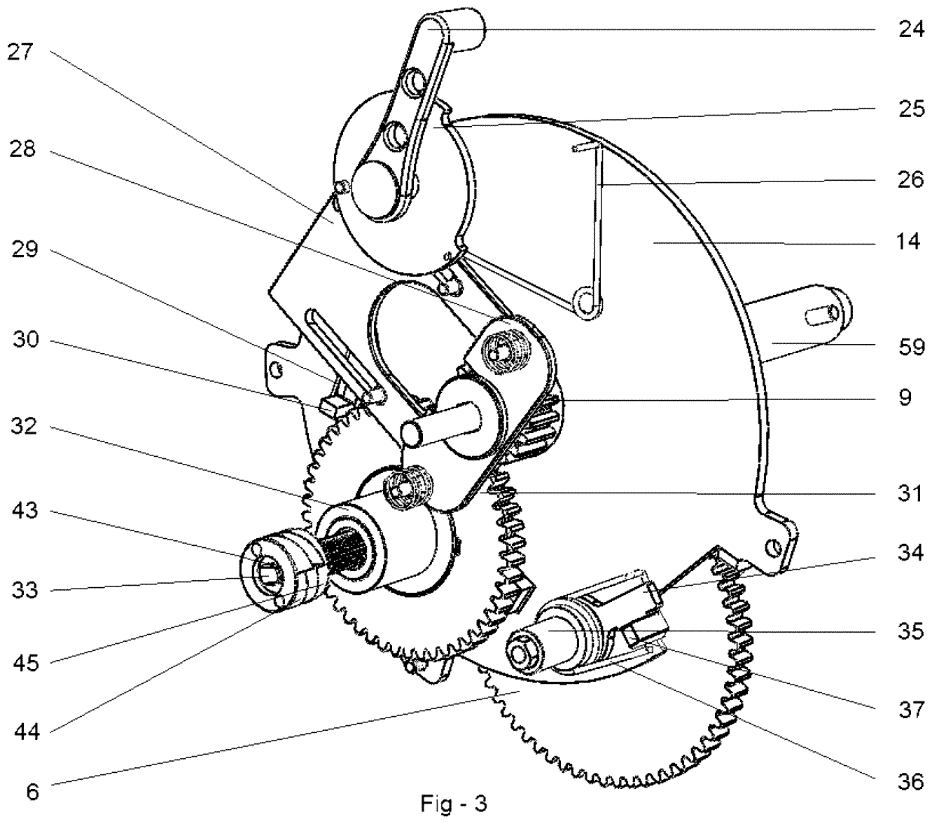

Referring now to FIG. 3, positioned on the lever arm drive shaft (54) protruding through the mounting plate (14) are the lever arm return spacer (35) and the lever arm return wheel (34). When in this non-working state, the lever arm return wheel (34) rests on the lever arm return wheel shoulder (37) and is tensioned by the lever arm return spring (36).

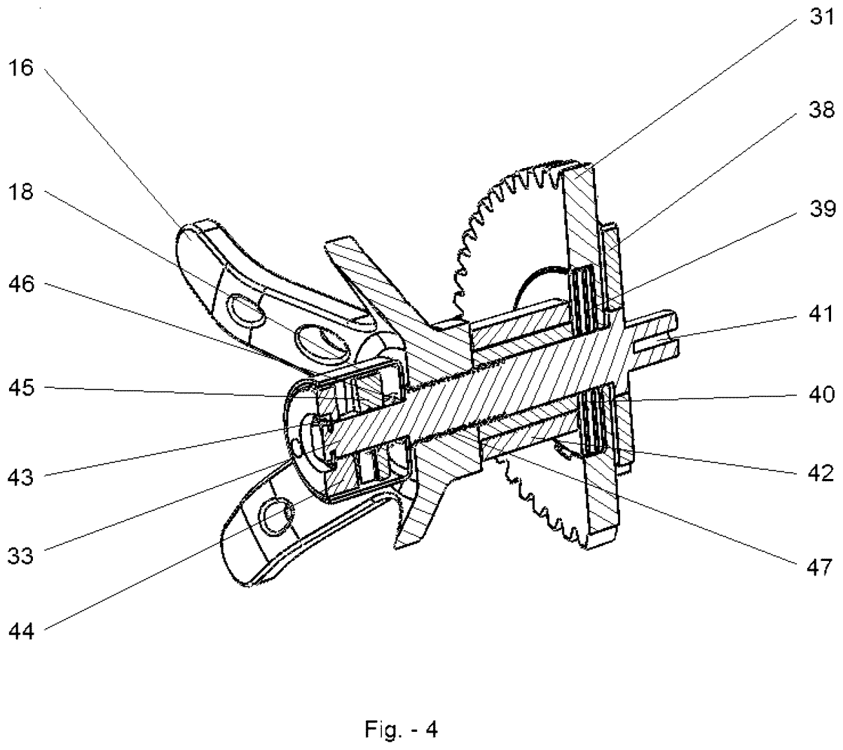

Referring now to FIG. 4., within the slip clutch assembly (18), which is mounted on the drive shaft (33) and secured by the clutch assembly e-clip (43), are the slip clutch “A” (44) and slip clutch “B” (45). A slip clutch spring (46) is placed in the assembly behind slip clutch B (45).

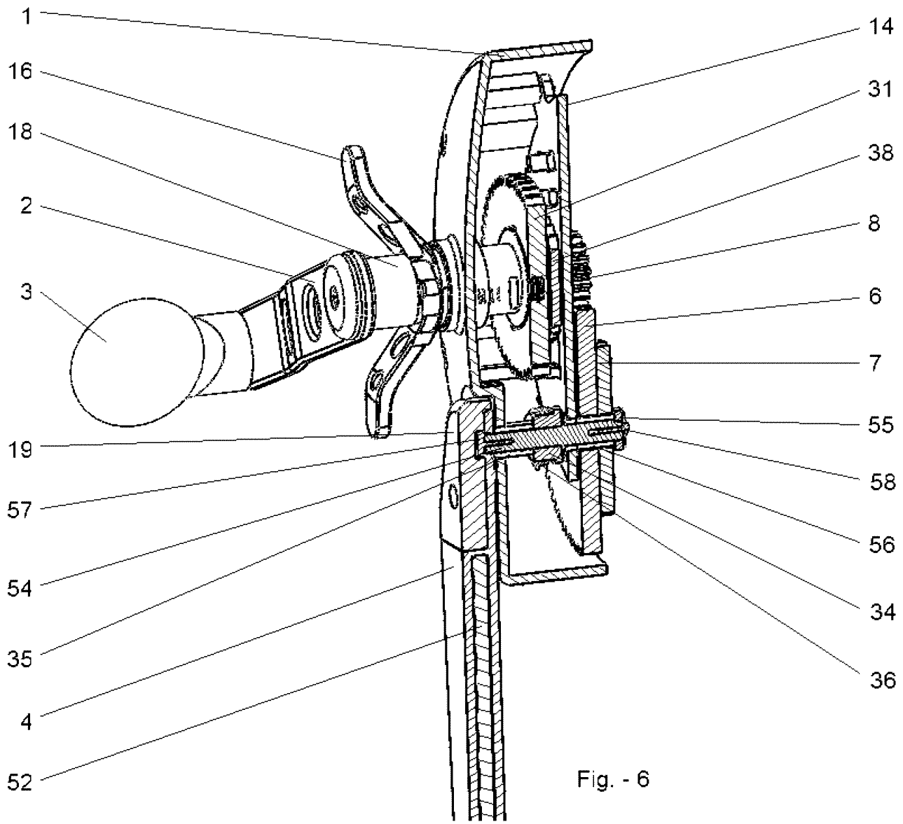

The lever arm mount plate (50) has a lever arm cover threaded screw mount (48) and a lever arm mount hole (49), which allows the entire assembly to be positioned on the pull lever arm drive shaft (54), which is shown in FIG. 6.

Referring now to FIG. 6, The clutch system assembly (18) is located between the star drag and crank and is positioned on the drive shaft (33). The lever arm (4) is positioned on the lever arm drive shaft (54) and is held in place by the lever arm shaft bolt (57), which is covered by the lever arm bolt cover (19). A lever arm return wheel spacer (35) is positioned on the lever arm drive shaft (54). Next to the lever arm return wheel spacer (35) is the lever arm return wheel (34) and the lever arm return wheel spring (36). On the exterior side of the mounting plate are the lever main gear (6), lever ratchet gear (7) and pull lever driven gear (8).

The lever main gear (6), lever ratchet gear (7), lever bushing (56) and lever ratchet arm (55) are positioned on the lever arm drive shaft (54) and secured on the shaft by a lever shaft end screw (58).

In the non-working operational state, the lever arm (4) is maintained in the position that is parallel to the fishing rod, as shown in FIG. 2. That positioning is caused by the lever arm return spring (36) exerting pressure on the lever arm return wheel (34) and consequently resting it on the lever arm return wheel shoulder (37). When in the non-working state, the angler is able to use the traditional method of turning the crank (2) using the crank handle (3)—not parts of the present invention—to bring in the line.

In the operational state, the lever arm (4) is pulled up towards the angler's body. As the lever arm (4) is being pulled, a ratcheting action occurs inside the reel assembly as follows: the lever gear (6) located on the other side of the mounting plate (14) and installed on the lever arm drive shaft (54) rotates clockwise; the lever ratchet gear (7), which is installed on the lever arm drive shaft (54) adjacent to the lever gear (6), also turns clockwise and, as it turns, the arm pawl (10) that is attached to the lever ratchet arm (55) with a pawl pin (13), which is tensioned with a pawl torsion spring (12), is driven over the lever ratchet gear (7) until it contacts the pawl stopper/limiter (11) creating the ratcheting action. Once the lever arm (4) reaches a position approximately perpendicular to the rod, it then returns to its initial position parallel to the rod in the countermotion.

The ratchet anti-reverse mechanism prevents pull lever main gear (6) to rotate back as follows: as the lever arm (4) is being pulled down, the slip clutch spring (46) presses onto the slip clutch A (44) and the slip clutch B (45); thus, preventing the crank (2) from rotating. Once the lever arm (4) is returned to its ‘non-working state’ parallel to the rod, the slip clutch A (44) and the slip clutch B (45) are disengaged, and the angler can revert to the traditional method of rotating the spool by utilizing the crank (2) and crank handle (3).

As the lever arm (4) is pulled toward the drive shaft (33) and the angler, the arm return wheel (34) that is spring loaded by the arm return spring (36), both of which are mounted on the lever arm drive shaft (54) and positioned on the arm return wheel shoulder (37) while in the ‘non-working’ position, are rotated toward the drive shaft (33) in the same manner as the lever arm (4).

Prior to ratcheting the lever arm (4), the length of lever arm (4) can be adjusted by putting downward pressure on the lever arm extender lock (21) thereby releasing it from its current lever arm extension position notch (53) and allowing the lever arm extendable handle (5) be pulled in or out as desired. The lever arm extender lock (21), which is held in place by the lever arm extender lock screw (22), then travels along the lever arm extension channeled notch (51), which is cut inside the lever arm extension slide surface (52) until it finds another lever arm extension position notch (53) to fill. This process allows the lever arm (4) mechanism to be adjusted at a desired length.

When the lever arm (4) is being returned to a ‘non-working’ position, the arm pawl (10) disengages from the lever ratchet gear (7) and prevents any further rotation of the lever gear (6) and lever ratchet gear (7) until the lever arm (4) is once again pulled toward the drive shaft (33). Pulling the lever arm (4) upward rotates the lever arm drive shaft (54), which subsequently causes the lever main gear (6) to rotate. As the lever main gear (6) rotates clockwise, it contacts the lever drive gear (8), which simultaneously rotates counterclockwise and subsequently then rotates the drive shaft (33) on which it is mounted. This drive shaft (33) rotates the drive gear (31) which in turn rotates the engaged pinion gear (9) causing the spool shaft it is mounted on to rotate counterclockwise.

As the spool shaft rotates, the spool winds the line and brings it in. As this process is occurring, the crank (3) is prevented from rotating on its axis by the clutch system assembly (18) with the slip clutch B (45) being disengaged from the slip clutch A (44); thus, allowing the lever arm (4) to be utilized without the crank (2) being rotated.

When the pull lever arm (4) is moved back and positioned on the arm return wheel shoulder (37), the traditional method of using the crank (2) and the handle (3) is enabled.

The lever arm extendable handle (5) can be adjusted relevant to the lever arm (4). This is done by manually pushing down on the lever arm extender lock (21), which is attached to the lever arm (4) by the lever extender lock screw (22) and disengaging the lever arm extender lock (21) from one of the pluralities of the lever arm extension position notches (53).

As the lever arm expandable handle (5) is pulled away, the lever extender lock (21) slides along the lever arm extension channeled notch (51), which is cut into the lever arm extension slide surface until the lever arm extender lock (21) locates another lever arm extension position notch (53), subsequently filling it, and locking the lever arm extendable handle (5) in place. In order to retract the lever arm expandable handle (5) to its original position, the lever arm extender lock (21) is pushed down, and the lever arm extendable handle (5) is pulled until the lever arm extender lock (21) fills the desired lever arm extension position notch (53).

It should be appreciated from the forgoing that the invention described herein offers the device for reeling in fishing tackle using a lever-based mechanism.

The description of the present embodiment has been presented for purposes of illustration but is not intended to be exhaustive or to limit the invention to the form disclosed. Many modifications and variations will be apparent to those of ordinary skill in the art. For example, increasing/decreasing the size/number of the gears therefore changing the speed/ratio at which the line is reeled in by multiplying the spool rotation per lever arm pull, increasing, or decreasing the size of the lever arm to accommodate bigger or smaller anglers, creating a ‘snap-on’ mechanism to interchange the lever arms easier and faster, among others.

The present invention can be affixed and used in conjunction with fishing reels produced by most major fishing reel manufacturers. Furthermore, the specifications of this design can be altered and modified to better fit non-standard fishing reel designs.

Herein above, or in the following claims, the term “comprises” is synonymous with “includes.” The use of terminology such as “X comprises A, B and C” is not intended to imply that A, B and C are necessarily the only components or most important components of X.

Unless clearly and explicitly stated, the claims that follow are not intended to imply any particular sequence of actions. The inclusion of labels, such as a), b), c) or 1), 2), 3) etc., for portions of the claims does not, by itself, imply any particular sequence, but rather is merely to facilitate reference to the portions.

To reiterate, the embodiments were chosen and described in order to best explain the principles of the invention, the practical application, and to enable others of ordinary skill in the art to understand the invention. Various other embodiments having various modifications may be suited to a particular use contemplated but may be within the scope of the present invention.

We claim:

1. A device for reeling in fish comprising:
crank gear;
an adjustable lever arm;
an adjustable lever arm drive shaft;
an adjustable lever main gear;
an adjustable lever ratchet gear;
a clutch;
a spool;
wherein when said adjustable lever arm is being moved up said adjustable lever arm drive shaft causes said adjustable lever main gear to oscillate the spool in a manner such that fishing line positioned on the spool is reeled onto the spool with hooked fish;
wherein when said adjustable lever arm is being moved down said adjustable lever ratchet gear prevents said adjustable lever main gear from oscillating the spool so that the spool can be oscillated by rotating said crank gear;
wherein said adjustable level lever arm can be installed on either side of the device and be operated by a right- or left-handed person; and
wherein, when said adjustable ever arm is being moved up, said clutch prevents rotations of said crank gear.

2. (canceled)

3. (canceled)

4. (canceled)

5. (canceled)
